(19) United States
(12) Patent Application Publication
(10) Pub. No.: US 2002/0106308 A1
(43) Pub. Date: Aug. 8, 2002

(54) Microdrop dispensing apparatus

(76) Inventors: Ronald A. Zweifel, Naperville, IL (US); Christopher M. Hahn, Downers Grove, IL (US)

Correspondence Address: JENKENS & GILCHRIST, P.C., 225 WEST WASHINGTON, SUITE 2600, CHICAGO, IL, 60606, US

(21) Appl. No.: 09/776,427

(22) Filed: Feb. 2, 2001

(51) Int. Cl. B01L 3/02

(52) U.S. Cl. 422/100; 422/67; 73/863.01; 73/864.01; 73/864.24; 73/864.25

(57) ABSTRACT

A method and apparatus for preventing or limiting damage to capillaries used to dispense microdrops measures the voltage produced by a piezoelectric transducer when the capillary contacts a solid surface or the phase shift occurring when the piezoelectric transducer is operated at its resonant frequency. After distinguishing the voltage created from such contact from the voltage produced from unrelated random sources, corrective action is taken, in one aspect by stopping the relative movement of the capillary and the surface being contacted. The method and apparatus may also be employed to determine the position of a solid or liquid surface.

### BACKGROUND OF THE INVENTION

The invention relates generally to apparatus for depositing small droplets of liquid. More particularly, the invention has application to the type of apparatus discussed in, for example, in PCT publication WO 98/45205, assigned to the Packard Instrument Company, which describes equipment capable of aspirating a liquid and dispensing it in droplets having a volume in the range of 5 to 500 picoliters. Such small droplets are ejected from the tip of a capillary by applying a voltage pulse to a piezoelectric transducer surrounding the capillary, producing a force sufficient to dispense one or a series of small droplets having a diameter similar to that of the opening of the capillary. Although there are various end uses for such equipment, it is particularly useful in connection with microscale chemical and biological analysis. The published PCT patent application suggests means for cleaning the tip of such capillaries which may easily become clogged. The present invention solves another problem to which the equipment may be subject, namely damage to the capillaries during the use of the apparatus. In addition, the invention has application to determining the position of a solid or a liquid surface.

In a typical operation, the tip of a capillary is moved into contact with liquid in a container and the liquid is aspirated, after which the capillary is moved to another location, where the liquid is dispensed in one or more droplets as desired. Then the capillary may be moved to another location, where additional droplets are dispensed or to a wash station where the capillary is cleaned before being used to aspirate and dispense another sample of liquid. It is also possible to maintain the capillary in one location and to move the containers or the surfaces which receive the liquid droplets under the capillary. Generally, such operations require the capillary to be moved vertically downward so that the tip is brought close to the bottom of the sample container or surface and then moved upwardly so that the sample container or surface can be exchanged for another. The capillaries are commonly made of glass and can easily be broken if they contact a sample container or surface. This not only interrupts the process being performed, but it is costly to replace the capillaries and the associated piezoelectric transducers. The breakage problem is multiplied when the number of capillaries is increased or the sizes of the associated sample containers and surfaces are decreased relative to the size of the capillaries.

For most practical applications of this technology the process must be automated. It can be appreciated that if the tip of a capillary is brought to within about 0.4 mm of the bottom of a sample container or another surface, that positioning the tip is difficult to do manually and damage to the tips could easily occur. If multiple capillaries are used, the damage potentially could be very great. Small errors in the positioning of the sample containers or droplet receiving surfaces can cause a capillary to unintentionally contact the wall of the sample container or the surface and to break. This may result from errors in programming, but even if the operator of such equipment has accurately programmed the movement of the capillaries for the necessary movements in three dimensions, it is still possible for errors in positioning of the sample containers or surfaces to lead to expensive damage to the capillaries.

Frequently, the microdispensing apparatus will be used to aspirate samples from a microplate having an array of small wells which hold liquid. A common size is a 96 well plate, measuring about 80 by 120 mm and having round sample wells having a diameter of about 6.5 mm. However, more recently plates having 384 and 1536 wells have become available. These have the advantage of further reducing the volume of the liquids needed to fill a well. However, these newer plates have the disadvantage of having sample wells which are much smaller than those in the 96 well plates. For example, the 384 well plate will have square wells with each side only 3.6 mm, while a 1536 well plate will have square wells with each side less than 1.5 mm. When one considers that the outside dimension of a typical capillary is only about 1 mm, it is evident that there is very little room for error in programming the three-dimensional movement of the capillaries or in positioning of the sample containers or surfaces. Therefore, the present inventors have addressed the problem of preventing or at least minimizing the possibility of contact between the capillaries and the sample containers or surfaces, so that the microdrop dispensing equipment can be used commercially with little or no downtime resulting from damage to the delicate capillaries. Their solution to the problem is described below in detail. In one broad aspect their invention involves using the capillary with its piezoelectric transducer to detect contact with the solid surfaces, such as sample wells or droplet receiving surfaces and taking corrective action to prevent or at least to limit damage to the capillaries. The invention may also be applied to detect the location of a solid or a liquid surface.

### SUMMARY OF THE INVENTION

In one aspect, the invention is a method of detecting when a capillary for dispensing liquids by action of a piezoelectric transducer comes in contact with a surface. The electrical voltage created by the piezoelectric transducer in response to such contact is detected and corrective action can be taken to avoid breakage of the capillary. In a related aspect, the electrical voltage change created when the capillary touches a surface is used to establish the position of a surface, either liquid or solid surface.

In another embodiment, the invention is a method of detecting when a capillary for dispensing liquids by action of a piezoelectric transducer comes into contact with a surface, in which the piezoelectric transducer surrounding the capillary is driven with a low oscillating voltage at its resonant frequency to establish a signal corresponding to the capillary and an inverted signal is created in phase with the signal of the capillary as a reference. When the capillary contacts a surface, the phase shift of the capillary signal relative to the reference signal is detected, and triggers corrective action. In a related aspect, the phase shift just described is used to establish the position of a surface, either liquid or solid. Preferably, the phase shift can be readily detected by summing the voltage potentials and detecting the voltage change.

In another aspect, the invention is an apparatus for dispensing microdrops of liquid by the action of a piezoelectric transducer in which the transducer is used to detect the contact with a solid surface by the capillary used to dispense the microdrops and to prevent damage to the capillary, or alternatively to establish the position of a surface, either liquid or solid. In one embodiment, the voltage produced when contact is made with a surface is made is used to detect contact. In another embodiment, the capillary is driven at its resonant frequency to establish a capillary signal, which is compared with an inverted signal as a reference and the phase shift between the signals resulting from contact of the capillary is detected. Preferably, the phase shift is detected by summing the voltage potentials and detecting the voltage change.

In still another aspect, the invention is the improvement in a capillary equipped with a piezoelectric transducer for expelling small droplets of liquid from the tip of the capillary when a voltage is applied to the piezoelectric transducer, and in which the transducer is used to detect contact with a surface. In one embodiment, the contact with a surface creates a voltage from the force applied to the transducer by contact with a surface. In another embodiment, the capillary is driven at its resonant frequency to establish a capillary signal, which is compared with an inverted reference signal and the phase shift between the signals produced by contact is detected. Corrective action can be taken typically by stopping movement of the capillary to prevent damage to the capillary. Alternatively, the technique can be used to establish the position of a solid or liquid surface.

### BRIEF DESCRIPTION OF THE DRAWINGS

FIG. 1 is a graph of the voltage generated when a capillary hits a solid surface in the vertical (Z) direction.

FIG. 2 is a graph of the voltage generated when a capillary hits a solid surface in the horizontal (X-Y) plane.

FIG. 3 is a graph of the voltage generated in a second type of contact of a capillary with a solid surface in the horizontal (X-Y) plane.

FIG. 4 is a graph of the unfiltered voltage generated by the excursion when the capillary contacts a solid surface plus an overlay of the amplified voltage produced by the capillary contact. The random noise has not been filtered.

FIG. 5 is a block diagram of the control systems used to operate the micro dispensing apparatus and to prevent breakage of the capillary.

### DESCRIPTION OF THE PREFERRED EMBODIMENTS

Microdrop Dispensing Apparatus

As mentioned above, the invention has particular relevance to apparatus used to dispense very small drops of liquid, such as those described in detail in PCT publication WO 98/45205 by the Packard Instrument Company. The microdrop dispensing systems will be described briefly here. For more details, reference may be made to the published patent application. The invention is not limited to the specific equipment described there, but may be applied to other equipment employing piezoelectric transducers to dispense drops of liquid.

Two types of liquid dispensing systems are described in WO 98/45205, both of which employ a capillary tube terminating in a smaller dispensing tip having an internal diameter of about 25 to 100 microns and capable of dispensing drops of liquid having a volume of about 5 to 500 picoliters. By surrounding the capillary tube with a piezoelectric transducer, it is possible to apply a voltage pulse, e.g. between about 40 and 300 volts to the transducer, which is mechanically deformed, compressing the capillary and expelling a drop of liquid. When the voltage is applied for a very short time a single drop is expelled. If the voltage is applied with a frequency up to about 1,000 Hz, a series of droplets can be expelled to provide the volume of liquid which one wishes to dispense.

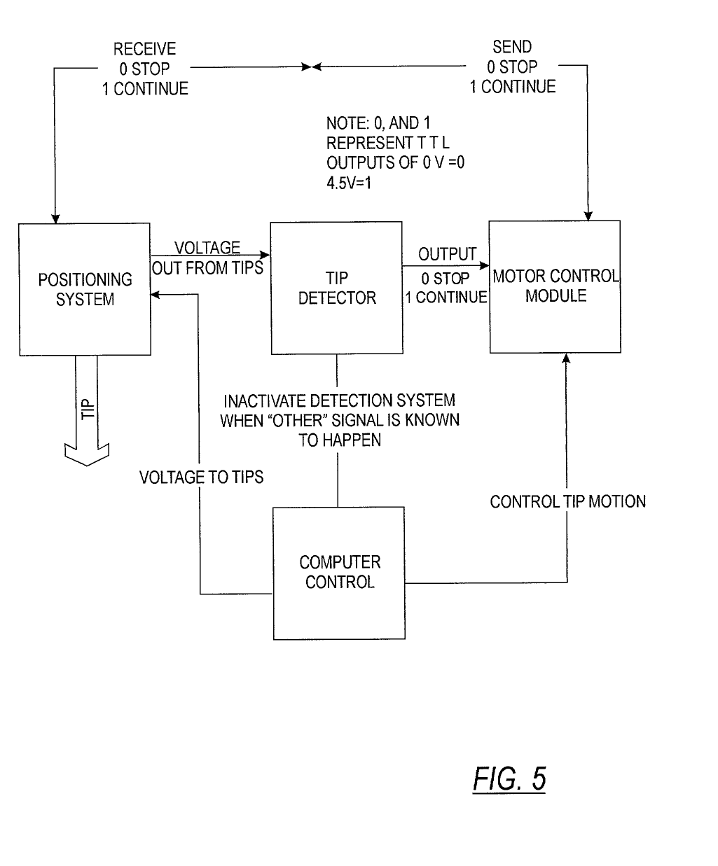

The published patent application describes generally the operation of a robotic system which positions the microdrop dispensing capillary tip over a sample liquid in its container, such a microplate shown in FIG. 5 of the application. The tip is moved until it makes contact with the surface of the liquid in the container, which contact may be sensed by a capacitive liquid level sensing system, so that the movement of the capillary is stopped and the liquid is aspirated into the capillary. Then, the capillary can be moved to another location and the aspirated liquid dispensed as desired. The published patent application also describes an optical method of positioning the capillary tip within each well of a microplate.

While the description herein is principally concerned with apparatus in which the capillary is moved from one location to aspirate liquid and to a second location to dispense microdrops of the liquid, it should be understood that the opposite arrangement is feasible and may be preferred for large scale commercial use. That is, in the simplest form, a single capillary is mounted on a moveable support and moved horizontally in the X-Y plane and vertically in the Z direction into a first location, such as the well of a microplate to aspirate a liquid and then to a second location, such as a planar surface on which microdrops of the liquid are dispensed. Thus, the capillary moves while the liquid containers e.g. a sample well or the surface which receives the microdrops are stationary. Alternatively, the capillary could be stationary and the container and surface could be moved under the capillary, which is moved only in the vertical direction (Z). Such an alternative arrangement may be desirable particularly when multiple capillaries are mounted in an array and it is more convenient to move the containers, sample plates and surfaces than to move the array of capillaries. It is of course possible to use an apparatus capable of moving each of the capillaries, the containers, the sample plates, and the surfaces independently for maximum flexibility of operation. Each embodiment is subject to the problems discussed above, since no matter which is used, movement may bring a capillary into contact with a container or a surface, resulting in damage to the capillary.

In practice, it is not desirable to carry out such movements manually, using visual observation by the operator. To assure accuracy in repetitive steps of aspirating and dispensing liquids, computer control of the movements of the capillaries generally will be provided. The operator of the apparatus will instruct the computer to carry out a series of movements intended to transfer liquid from a container and to dispense it into a second container or onto a surface such as a glass slide. For example, a capillary could be instructed to move to a first well containing liquid, aspirate a predetermined amount of the liquid, move to a predetermined location over a glass slide, and dispense a single drop of the liquid there, then move to other positions on the same slide and dispense additional drops of liquid. After dispensing the desired amount of liquid, the capillary tip could be instructed to move to another location where it would be washed before the cycle is repeated. It will be appreciated that such a sequence of movements will take place in three dimensions, usually called X and Y defining the position in a horizontal plane and Z defining the position in the vertical direction. Since the capillaries are very small, one can appreciate that they can be easily damaged if, during their travels in the X, Y and Z directions, they come in contact with an obstacle, such as the well of a microplate or the surface of a glass slide. While it might be thought that the computer control could eliminate concern over such contacts, errors can occur leading to damage of the capillaries. These errors are generally of two types, the first, errors in programming of the computer control and the second, errors in positioning of the containers or the slides. The present inventors cannot prevent errors made by others, but they have developed a method for limiting or preventing the damage to capillaries which could otherwise occur.

The nature of the problem can be understood more easily when the dimensions of the capillary and the associated containers and surfaces and the distance between them are considered. The usual capillary has an internal diameter of about 300-800 microns and an external diameter of about 500-1,000 microns (0.5-1 mm). At the tip the capillary is reduced to an external diameter of about 100 microns and the dispensed droplets are even smaller. The 0.5-1.0 mm o.d. capillary will be inserted into the well of a microplate which has a diameter of no more than 6 mm and, often is as small as 2.6 mm square, sometimes with a 1,536-well microplate a wall of about 1.5 mm square. The capillary tip may approach the bottom of the well within about 0.4 mm or 400 microns, or a similar distance from a glass slide on which it is to deposit a single drop. There is very little room for error in positioning the capillary and experience has shown that damage to the capillary is frequent enough to present a significant problem. Since the capillaries are very small and generally made of glass, very little force is required to break them. Thus, any contact between a capillary and any solid surface which could result in breakage must be detected quickly and corrective action taken at once.

While the above discussion considered the movement of a single capillary, when the microdrop dispensing method is applied on a large scale commercially, it is probable that many dispensing capillaries will be in operation simultaneously. For example, four up to a number equal to the number of containers from which liquid is to be aspirated. Therefore, potentially all of the many capillaries could be broken at the same time by a positioning error. Since each one is expensive, breaking many at one time must be prevented, as is possible with the present invention.

Detecting and Preventing Damage to Capillary Tips

Each capillary dispenses one or more drops when a piezoelectric transducer surrounding the capillary is activated by applying a brief voltage pulse, thereby compressing the capillary tube and expelling a drop for each pulse. The piezoelectric transducer can operate in a reverse manner, that is, it can create an electrical voltage if it is mechanically strained, a principle which is used for applications such as record players, cigarette lighters, igniters on barbecue grills and some microphones and speakers. The voltage produced by a piezoelectric transducer is related to the force applied to the transducer. In the present invention, the voltages generated and detected are generally quite small compared to the voltage used to compress a capillary tube and expel a liquid droplet, e.g., about 40 to 300 volts. Thus, while it might be anticipated that a capillary with a piezoelectric transducer could produce a voltage if the tip contacts a solid surface, it is not evident that the voltage could be distinguished from the random “noise” resulting from unrelated sources, so that it can be used to prevent breaking the tip, or to establish the position of a surface. The present inventors have found that to be possible, with the methods and apparatus to be described.

When the piezoelectric transducer is distorted mechanically so as to compress the capillary and dispense a liquid droplet, a relatively high voltage is used, as previously discussed. In contrast, when a capillary touches a solid surface during operation of the microdrop dispensing apparatus, a very small voltage of at least 10 millivolts (0.01 volt) is typically produced. At the same time, the capillary is constantly producing “noise”, that is, voltage produced by the transducer from mechanical forces introduced by the movement of the capillary, the driving motors, external vibrations, and the like. Thus, if one measures the voltage being produced by the piezoelectric transducer while it is not dispensing droplets, it is found that an irregular random voltage is always being produced, typically of a similar order of magnitude as the voltage produced by contact with a surface. Such noise would not ordinarily be of concern and would be small enough in size as to have no significant effect on the dispensing of droplets. However, it is of a magnitude which can mask the voltage produced by contact of the capillary with a solid surface, especially if the contact is slow, as it often is when contact occurs in the X-Y (horizontal) plane. Vertical contact in the Z direction often produces a more pronounced reaction. Examples of such contacts between a capillary and the wall of a container and between the tip of the capillary in the horizontal plane and a solid surface in the Z direction are shown in the Figures.

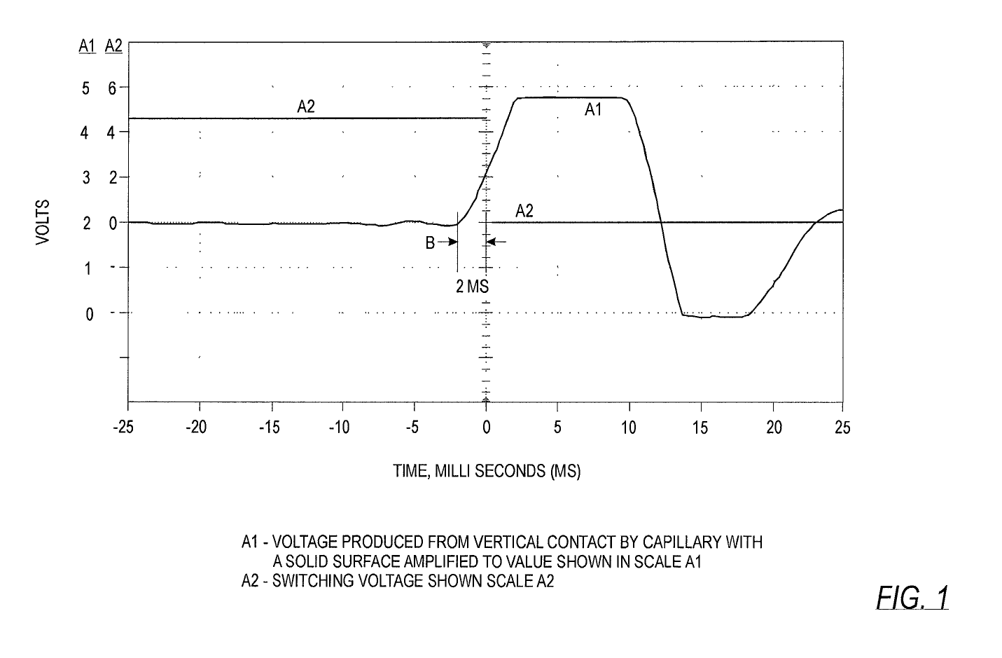

In FIG. 1, a “hard” contact was made between a capillary and a solid surface in the Z (vertical) direction. The reference voltage is shown as a baseline bias voltage of two volts. When the capillary touches a surface a voltage change is produced (A1) from the strain in the piezoelectric transducer. The actual voltage has been amplified to show the variation from the baseline bias voltage of 2 volts.

A2 shows the voltage of about 4.5-5 volts used to establish a baseline for determining whether contact has occurred. When the voltage rise caused by the contact of a capillary reaches the switching threshold, the switching voltage is dropped to zero, causing the motor control module (see FIG. 5) to stop movement of the capillary to prevent breakage. The corrective action took place within 2 milliseconds after the voltage increase began, as shown by the voltage drop from 4.5-5 volts to zero as the controlling switch is opened.

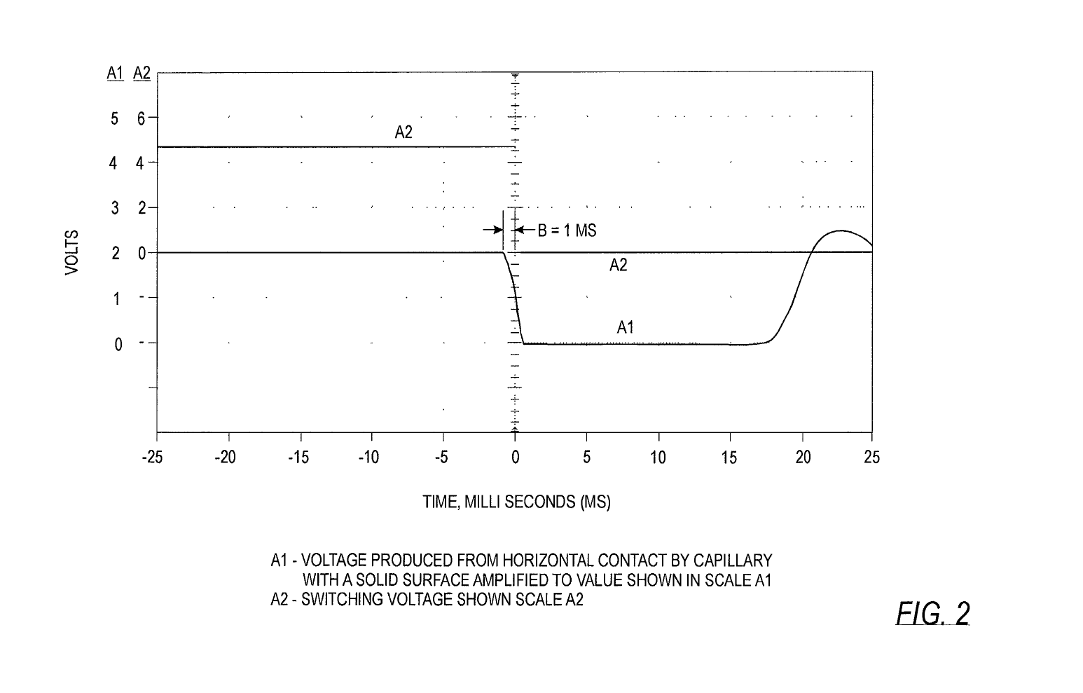

FIG. 2 illustrates the result of a capillary moving horizontally at 7.5 inches/second (190 mm/sec) coming into contact with the wall of a cell in a sample plate. As in FIG. 1, the reference voltage has been shown as a nominal bias of two volts. When the capillary touched the cell wall, a voltage change was produced and detected in about one millisecond, as can be seen on the horizontal scale, triggering corrective action. In this instance, the voltage excursion was negative, rather than positive, as in FIG. 1. Either negative or positive excursions may occur, depending on the direction of the strain on the piezoelectric transducer.

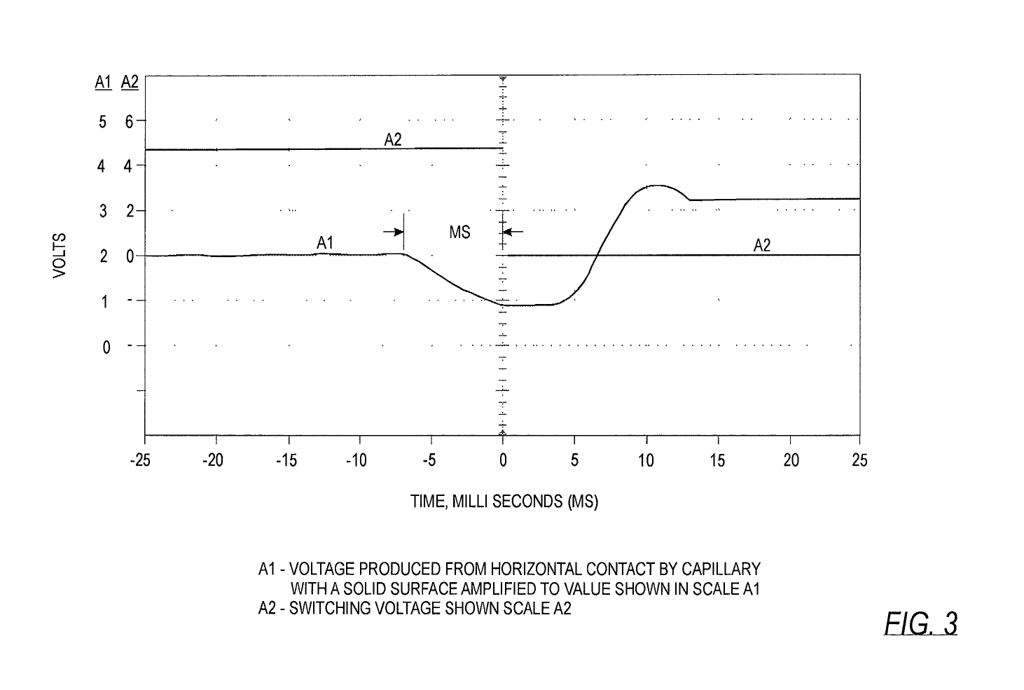

In FIG. 3, a “soft” contact was made between a capillary moving at 7.5 inches/second (190 mm/sec) and a solid surface in the X-Y plane. The voltage excursion was slower than in FIG. 2, but the result was similar. In about 7 milliseconds, the voltage excursion in A1 was detected and corrective action taken, as shown by the drop to zero voltage from the switching circuit (A2).

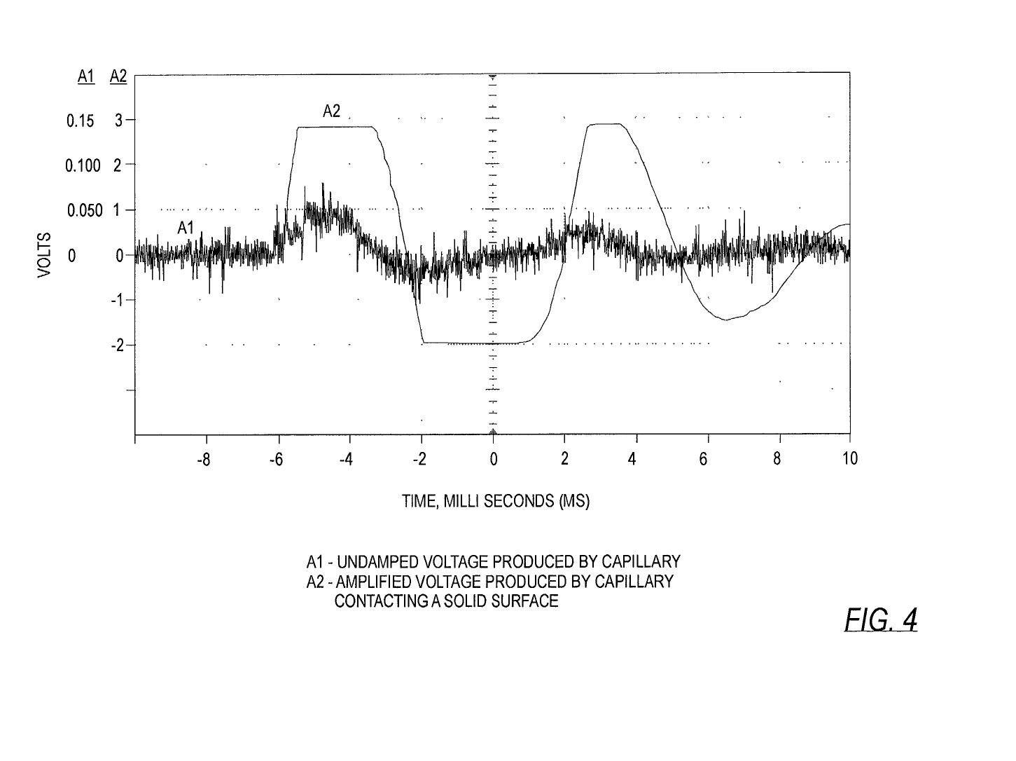

FIG. 4 shows the “raw” voltage (A1) associated with a capillary when it is being moved, but not dispensing droplets. The scale for this data is 50 millivolts per division, indicating that the random noise is typically less than ±50 millivolts. The actual voltage produced when a capillary contacts a solid surface is also small, in this Figure up to about 75 millivolts. The relatively small voltage excursion is amplified to provide a signal which is detected, as shown in the previous figures. This Figure illustrates the relationship between the actual voltage and the amplified signal. The “noise” is distributed uniformly about zero voltage and is filtered out. Only the excursion caused by contact of a capillary with a solid surface is amplified (A2).

FIG. 5 is a block diagram illustrating the controls used to position the capillaries. The “tip detector”system receives the voltage being generated by a capillary, distinguishes between “noise”and a voltage generated by the piezoelectric transducer when the capillary contacts a solid surface, sends a signal to the motor control module to stop movement of the capillary. If no voltage excursion is detected, then the tip detection system signals the motor control module to continue its normal routine.

The diagram, omitting the tip detection system, illustrates the general operation of the microdrop dispensing apparatus. A capillary (or more typically multiple capillaries) is moved to a predetermined position and one or more drops are dispensed by applying a relatively high voltage to the piezoelectric transducer surrounding the capillary. Then, the capillary is moved to the next predetermined location by the positioning system as directed by the motor control module, which is instructed by the computer which controls the overall operation of the apparatus. The computer directs application of dispensing voltage to the capillary and also inactivates the tip detection system when voltage is to be applied to the transducer or at other times, such as when aspirating liquids or cleaning the capillaries.

The above discussion relates to a method in which the voltage created when a capillary contacts a solid surface is distinguished from random “noise” and used to stop the relative movement of the capillary and a sample plate or surface with which the capillary is being used. Alternatively, the invention also includes a method in which the capillary is pulsed at its resonant frequency with a voltage which does not cause droplets to be expelled. An inverted phase is provided as a reference signal so that the two frequencies are in phase. When the capillary contacts a surface; the resonant frequency is shifted in phase from the inverted resonant frequency. By measuring the phase change relative to the inverted signal used as a reference, a signal is sent to the motor control module of FIG. 5 to stop further movement.

The resonant frequency may be determined for each capillary by increasing the frequency of the applied voltage until the resonant frequency is reached. Then, in a preferred embodiment, an inverted signal at the resonant conditions for the capillary is created as a reference. The two are in phase with each other as long as the capillary is not touching a surface and is oscillating at its natural resonant frequency. However, when the capillary touches a surface, the oscillation of the capillary is no longer in phase with the inverted signal which had been created as a reference. Although the voltage change which results is small, the phase shift is large. One method of detecting this phase shift is to sum the reference signal with the signal from the capillary. Usually, the sum of the signals cancel each other out and result in a zero voltage reading. When the phase of the capillary changes only slightly, the sum of the signals is no longer zero. The voltage change is read as being the result of the capillary touching a surface, then a signal to the motor control unit stops movement of the capillary, in a similar manner as that described for the first embodiment.

Detecting the Position of Surfaces

Although the invention has a particular value in preventing capillaries from being broken during operation of a microdrop dispensing apparatus, it can also be used to detect the position of surfaces. For example, in some applications it will be necessary to position droplets precisely on the surface of a flat slide. Since the capillary tip will closely approach the surface before dispensing a droplet, it is important to know where the surface is. As noted earlier, the approach distance may be about 0.4 mm. Where multiple droplets are to be rapidly dispensed, each at a different location on a slide, knowing where the surface is positioned is important. The invention can be used to locate the surface of a slide by the voltage change when contact is made or the voltage resulting from the phase shift compared to an inverted reference as in the second embodiment. In this use, no further movement toward the surface would made, but the motor control unit could be instructed to note the position of the surface for subsequent dispensing of droplets and to proceed with the regular dispensing program.

The same general method may be used to detect the position of a liquid surface, which might be liquid in a sample well or in a container from which liquid is to be aspirated. It is believed that the method of the second embodiment described above is especially useful in locating the position of liquid surfaces.

1. A method of detecting contact between a surface and a capillary for dispensing liquids by action of a piezoelectric transducer disposed on said capillary comprising measuring the voltage produced by said piezoelectric transducer when said capillary contacts said solid surface.

2. A method of claim 1, wherein said produced voltage is measured when said capillary is not dispensing liquid.

3. A method of claim 1, wherein said produced voltage is distinguished from random voltage produced by the transducer from sources unrelated to dispensing liquids or contacting of said capillary with a surface.

4. A method of claim 3, wherein said produced voltage is amplified and compared with a baseline voltage.

5. A method of detecting contact between a surface and a capillary for dispensing liquids by action of a piezoelectric transducer disposed on said capillary comprising:
(a) providing an oscillating voltage to said capillary at its resonant frequency to establish a signal corresponding to the capillary and creating an inverted signal at the resonant conditions as a reference, whereby the signals of the capillary and the reference are in phase with each other,
(b) measuring the phase shift between the signals of (a) which results when said capillary contacts said surface and causes the signal of the capillary to change relative to said reference signal.

6. A method of claim 5, wherein said phase shift is measured when said capillary is not dispensing liquid.

7. A method of claim 5, wherein said piezoelectric transducer is supplied in (a) with a voltage lower than the voltage required to dispense liquids.

8. A method of claim 5, wherein said resonant frequency is predetermined and used in step (a).

9. A method of claim 5, wherein the signal of the capillary and the reference signal are summed and the resulting voltage change is measured to indicate said phase shift.

10. An apparatus for dispensing microdrops of liquid comprising:
(a) at least one capillary for containing liquid and from which liquid microdrops are dispensed;
(b) a piezoelectric transducer disposed on said capillary, said transducer exerting pressure on liquid in said capillary when a voltage pulse is applied to said transducer, thereby dispensing liquid microdrops;
(c) means for positioning said capillary with respect to a predetermined location;
(d) means for measuring the voltage produced by said transducer when said capillary contacts a surface.

11. An apparatus of claim 10, wherein said piezoelectric transducer surrounds said capillary.

12. An apparatus of claim 10, wherein said voltage pulse of (b) is in the range of 40 to 300 volts.

13. An apparatus of claim 10, wherein said produced voltage of (d) is distinguished from voltage produced by said transducer from random unrelated sources.

14. An apparatus of claim 10, wherein further comprising means for preventing further contact of said capillary with said surface by stopping the means for positioning said at least one capillary.

15. An apparatus of claim 10, wherein said capillary is mounted on a movable support capable of positioning said capillary in a predetermined location.

16. An apparatus of claim 15, wherein said movable support is capable of positioning said capillary in a first location for aspirating said liquid and in a second location for dispensing microdrops of said liquid.

17. An apparatus of claim 16, wherein said first location is a well of a microplate and said second location is a planar surface.

18. An apparatus of claim 17, wherein said planar surface is a glass slide.

19. An apparatus of claim 10, wherein said capillary is mounted on a support and containers for said liquid and surfaces for receiving dispensed microdrops are mounted on movable supports capable of positioning said containers or surfaces under said capillary.

20. An apparatus of claim 19, wherein said container for liquid is a well of a microplate and said surface for receiving dispensed microdrops is a planar surface.

21. An apparatus of claim 20, wherein said planar surface is a glass slide.

22. An apparatus for dispensing microdrops of liquid comprising:
(a) at least one capillary for containing liquid and from which liquid microdrops are dispensed;
(b) a piezoelectric transducer disposed on said capillary, said transducer exerting pressure on liquid in said capillary when a voltage pulse is applied to said transducer, thereby dispensing liquid microdrops;
(c) means for positioning said at least one capillary with respect to a predetermined location;
(d) means for supplying an oscillating voltage to said capillary at its resonant frequency, and establishing a signal corresponding to the capillary, and creating an inverted signal at the resonant conditions as a reference in phase with the capillary signal.
(e) means for measuring the phase shift when said capillary contacts said surface and causing the frequency of the capillary to change relative to the reference signal.

23. An apparatus of claim 22, further comprising a means for determining said resonant frequency.

24. An apparatus of claim 22, wherein said means for measuring said phase shift includes means for summing the capillary signal and the inverted signal and measuring the resulting voltage and detecting a change.

25. An apparatus of claim 22, wherein said supplied voltage is lower than that required to dispense liquids.

26. An apparatus of claim 22, wherein said piezoelectric transducer surrounds said capillary.

27. An apparatus of claim 22, wherein said voltage pulse of (b) is in the range of 40 to 300 volts.

28. An apparatus of claim 22, wherein further comprising means for preventing further contact of said capillary with said surface by stopping the means for positioning said at least one capillary.

29. An apparatus of claim 22, wherein said capillary is mounted on a movable support capable of positioning said capillary in a predetermined location.

30. An apparatus of claim 29, wherein said movable support is capable of positioning said capillary in a first location for aspirating said liquid and in a second location for dispensing microdrops of said liquid.

31. An apparatus of claim 30, wherein said first location is a well of a microplate and said second location is a planar surface.

32. An apparatus of claim 31, wherein said planar surface is a glass slide.

33. An apparatus of claim 22, wherein said capillary is mounted on a support and containers for said liquid and surfaces for receiving dispensed microdrops are mounted on movable supports capable of positioning said containers or surfaces under said capillary.

34. An apparatus of claim 33, wherein said container for liquid is a well of a microplate and said surface for receiving dispensed microdrops is a planar surface.

35. An apparatus of claim 34, wherein said planar surface is a glass slide.

36. In a capillary for dispensing microdrops of liquid by applying pressure to said liquid with a piezoelectric transducer disposed on said capillary and actuated by a voltage pulse, the improvement comprising means for measuring the voltage change produced by said transducer resulting from contact of said capillary with a surface.

37. A capillary of claim 36, wherein said produced voltage is at least 10 millivolts.

38. A capillary of claim 36, wherein said produced voltage is distinguished from voltage produced by said transducer from random sources unrelated to dispensing liquids or contacting of said capillary with surfaces.

39. In a capillary for dispensing microdrops of liquid by applying pressure to said liquid with a piezoelectric transducer disposed on a capillary and actuated by a voltage pulse, the improvement comprising means for supplying an oscillating voltage to said capillary at its resonant frequency and establishing a signal corresponding to said capillary and for measuring the phase shift compared to an inverted signal at resonant conditions when said capillary contacts a surface.

40. A capillary of claim 39, wherein said improvement further comprises a means for predetermining said resonant frequency

41. A capillary of claim 40, wherein said voltage supplied to said capillary at its resonant frequency is lower than that required to dispense liquids.

42. A method of claim 1 wherein said voltage produced by said piezoelectric transducer is used to prevent further contact of said capillary with a surface by stopping movement of said capillary relative to said surface.

43. A method of claim 5 wherein said phase shift resulting from contact of said capillary with a surface is used to stop movement of said capillary relative to said surface.
